(19) United States
(12) Patent Application Publication
(10) Pub. No.: US 2024/0240878 A1
(43) Pub. Date: Jul. 18, 2024

(54) HEAT EXCHANGE FIN AND HEAT EXCHANGE DEVICE

(71) Applicant: A. O. Smith (China) Water Heater Co., Ltd., Nanjing (CN)

(72) Inventors: Tong LIU, Nanjing (CN); Zhiping ZHANG, Nanjing (CN); Chengjun ZHANG, Nanjing (CN)

(21) Appl. No.: 18/409,256

(22) Filed: Jan. 10, 2024

(30) Foreign Application Priority Data
Jan. 13, 2023 (CN) 202320115515.0

(51) Int. Cl. F28F 1/30; F24H 1/14

(52) U.S. Cl. CPC F28F 1/30; F24H 1/14

(57) ABSTRACT

The present application provides a heat exchange fin and a heat exchange device. The heat exchange fin comprises a plurality of water pipe through holes arranged side by side perpendicular to a flue gas flow direction, wherein a notch and a flanging hole are sequentially formed between the adjacent water pipe through holes along the flue gas flow direction, an edge of the notch is provided with a first flue gas baffle, and a first opening is formed at the center of the first flue gas baffle. In the present application, the temperature distribution of the heat exchange fin is more uniform, possibility of generation of the condensed water is reduced on the premise of ensuring heat exchange efficiency, thereby prolonging the service life of the heat exchange.

### CROSS-REFERENCE TO RELATED APPLICATIONS

This application claims priority to Chinese Application Number 202320115515.0, filed on Jan. 13, 2023, the subject matter of which is incorporated herein by reference.

### TECHNICAL FIELD

The present application relates to the technical field of a heat exchange device, and in particular to a heat exchange fin and a heat exchange device.

### BACKGROUND

As a core component of a heat exchange device, a heat exchange fin has an important effect on heat exchange efficiency and service life and the like of the heat exchange device. The heat exchange device usually uses high temperature flue gas generated by combustion of the gas to heat the cold water flowing through the heat exchange device, in which the heat exchange is performed mainly by the heat exchange fin. The high temperature flue gas heats the heat exchange fin when passing through the heat exchange fin, and then the heat exchange fin transfers the heat to the cold water in a water pipe on the heat exchange fin.

Generally, the heating flue gas of the heat exchange device flows from below the heat exchange fin to above the heat exchange fin, the flue gas flow heats the heat exchange fin while flowing through the heat exchange fin, so that the temperature below the heat exchange fin is high, and due to the blockage of a water pipe and other structures on the heat exchange fin, the gas flow through the heat exchange fin is not uniform, thus the temperature at each position of the heat exchange fin is not uniform, and the high temperature flue gas is easy to form the condensed water in the low temperature area, which affects the service life of the fin.

### SUMMARY

An object of the present application is to provide a heat exchange fin, on which the temperature distribution of the heat exchange fin is more uniform, and which reduces possibility of generation of the condensed water on the premise of ensuring heat exchange efficiency and prolongs the service life of the fin. Another object of the present application is to provide a heat exchange device.

In order to achieve the above object, one aspect of the present application discloses a heat exchange fin, comprising a plurality of water pipe through holes arranged side by side perpendicular to a flue gas flow direction, wherein a notch and a flanging hole are sequentially formed between the adjacent water pipe through holes along the flue gas flow direction, an edge of the notch is provided with a first flue gas baffle, and a first opening is formed at the center of the first flue gas baffle.

Optionally, the plurality of water pipe through holes include a plurality of rows of water pipe through holes sequentially arranged along the flue gas flow direction, wherein the water pipe through holes in each row are arranged side by side along a direction perpendicular to the flue gas flow direction, and the water pipe through holes in the plurality of rows are arranged in one-to-one correspondence along the flue gas flow direction.

Optionally, a protruding portion protruding toward an upper edge of the heat exchange fin is formed at a side of the notch that is close to the flanging hole.

Optionally, the first flue gas baffle is disposed at the protruding portion.

Optionally, a lower edge of the protruding portion is located above the water pipe through hole that is close to a lower edge of the heat exchange fin.

Optionally, the protruding portion is an inverted V shape, an arc shape or a bell-shape curve shape.

Optionally, the flanging hole is located above the water pipe through hole that is close to an upper edge of the heat exchange fin.

Optionally, at least one of the flanging holes is provided with a through hole along the flue gas flow direction.

Optionally, a recessed portion recessed toward the water pipe through hole is formed at an upper edge of the heat exchange fin correspondingly to the water pipe through hole.

Optionally, a second flue gas baffle corresponding to the flanging hole is disposed at the recessed portion.

Optionally, a second opening is formed at the center of the second flue gas baffle corresponding to the same water pipe through hole.

Optionally, a lower edge of the heat exchange fin is a straight line near an edge of the water pipe through hole.

The present application further discloses a heat exchange device, comprising two or more heat exchange fins as described above, wherein the two or more heat exchange fins are sequentially stacked and assembled together.

In the heat exchange fin of the present application, a notch and a flanging hole are sequentially formed between the adjacent water pipe through holes along a flow direction of a flue gas flow from bottom to top, a first flue gas baffle is disposed at an edge of the notch, and a first opening is opened at the center of the first flue gas baffle. In general, due to the obstruction of the water pipe arranged in the water pipe through hole, the flue gas flow is less above the water pipe, resulting in a lower temperature in the area above the water pipe through hole on the heat exchange fin; whereas in the present application, when the flue gas flow passes through the heat exchange fin of the present application from bottom to top, due to the blocking of the first flue gas baffle at the notch, the flue gas flow will be dispersed to both sides of the notch, which solves the problem of less flue gas in the water pipe through hole area, and can effectively increase the temperature above the water pipe through hole of the heat exchange fin. Due to the blocking of the first flue gas baffle, there is less flue gas above the first flue gas baffle. In the present application, a first opening is opened at the center of the first flue gas baffle to allow a portion of the flue gas flow to flow upwardly from the first opening, so as to solve the problem of less flue gas above the first flue gas baffle. A flanging hole is further arranged above the first flue gas baffle to disperse the flue gas flow to both sides of the flanging hole, so as to further solve the problem of less flue gas in the water pipe through hole area. Thus, in the present application, the flue gas flow of the heat exchange fin is dispersed uniformly, such that the temperature distribution of the heat exchange fin is more uniform, so as to increase the lowest temperature of the heat exchange fin, reduce possibility of generation of the condensed water on the premise of ensuring heat exchange efficiency and prolong the service life of the heat exchange fin. In addition, in the present application, the water pipe through holes may be provided in a plurality of rows, and the water pipe through holes at corresponding positions in the plurality of rows are arranged in up and down one-to-one correspondence, so as to be able to effectively reduce the highest temperature of the upper row of high-temperature water pipes, reduce the risk of fouling, and prolong the service life of the heat exchange device.

### BRIEF DESCRIPTION OF THE DRAWINGS

To illustrate more clearly the embodiments of the present application or the technical schemes of the prior art, a brief description of the accompanying drawings in the embodiments or the prior art will be given below. Obviously, the accompanying drawings described below are only some embodiments described in this application. For those of ordinary skill in the art, other drawings can also be obtained without any creative labor from these drawings.

FIG. 1 is a schematic diagram of a specific embodiment of a heat exchange fin of the present application;

FIG. 2 is a schematic diagram showing the flue gas flow in a specific embodiment of the heat exchange fin of the present application;

FIGS. 3 and 4 are schematic diagrams showing a partial area in a specific embodiment of the heat exchange fin of the present application.

### REFERENCE NUMERALS

1. heat exchange fin; 11. water pipe through hole; 12. notch; 121. protruding portion; 13. first flue gas baffle; 131. first opening; 14. flanging hole; 15. recessed portion; 16. second flue gas baffle; 161. second opening

### DETAILED DESCRIPTION

Hereinafter the technical solution in the embodiments of the present application will be described clearly and completely in combination with the accompanying drawings in the embodiments of the present application, and obviously the described embodiments are merely part of the embodiments, not all of the embodiments. Any other embodiments obtained by those skilled in the art based on the embodiments of the present application without paying any creative labor fall within the protection scope of the present application.

It should be noted that the terms “first,” “second” and the like in the description and claims of the present application and in the above-mentioned drawings are used to distinguish between similar objects and are not necessarily used to describe a particular order or precedence. It should be understood that the data so used may be interchanged where appropriate for the purpose of the embodiments of the present application described herein. Furthermore, the terms “comprising” and “having” and any variations thereof are intended to cover non-exclusive inclusions, such as, for example, a process, a method, a system, a product or a device comprising a series of steps or units need not to be limited to those steps or units that are clearly listed, but may include other steps or units that are not explicitly listed or inherent to these processes, methods, products or devices.

In the present application, the orientation or positional relationship indicated by the terms “on”, “under”, “left”, “right”, “front”, “back”, “top”, “bottom”, “inside”, “outside”, “middle”, “vertical”, “horizontal”, “transverse”, “longitudinal” and the like is based on the orientation or positional relationship shown in the drawings. These terms are mainly intended to better describe the present application and its embodiments and are not intended to limit that the indicated devices, elements or constituents must have a particular orientation, or be constructed and operated in a particular orientation.

The positional relationship such as “parallel” or “perpendicular” includes not only the positional relationship of exactly “parallel” or “perpendicular” but also the positional relationship that the angle deviation relative to exactly “parallel” or “perpendicular” is within the preset deviation range.

Also, in addition to being used to represent an orientation or positional relationship, some of the above terms may also be used to indicate other meanings. For example, the term “on” may also be used in some cases to denote a certain attachment or connection. The specific meanings of these terms in the present application may be understood by those ordinarily skilled in the art as the case may be.

In addition, the terms “installation”, “setting”, “being provided with”, “connecting”, “connected”, “sleeving” should be understood broadly. For example, the connection may be a fixed connection, a detachable connection or an integrated construction, or may be a mechanical connection or an electrical connection, or may be a direct connection, or may be an indirect connection through an intermediary, or an internal communication between two devices, elements or constituents. The specific meanings of the above terms in the present application may be understood by those ordinarily skilled in the art as the case may be.

It should be noted that the embodiments in the present application and the features in the embodiments can be combined with each other without conflict. Hereinafter, the present application will be described in detail with reference to the drawings and in connection with embodiments.

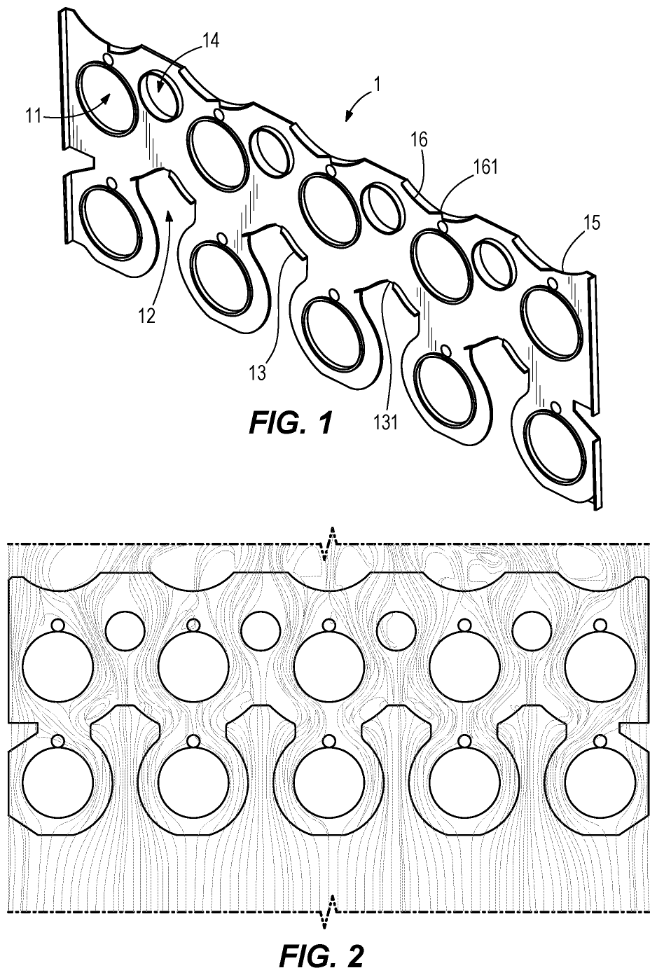

According to an aspect of the present application, the present embodiment discloses a heat exchange fin 1. As shown in FIG. 1, in the present embodiment, the heat exchange fin 1 comprises a plurality of water pipe through holes 11 arranged side by side perpendicular to the flue gas flow direction, wherein a notch 12 and a flanging hole 14 are sequentially formed between the adjacent water pipe through holes 11 along the flue gas flow direction, an edge of the notch 12 is provided with a first flue gas baffle 13, and a first opening 131 is formed at the center of the first flue gas baffle 13.

In the heat exchange fin 1 of the present application, a notch 12 and a flanging hole 14 are sequentially formed between the adjacent water pipe through holes 11 along the flow direction of the flue gas flow from bottom to top, a first flue gas baffle 13 is disposed at the edge of the notch 12, and a first opening 131 is opened at the center of the first flue gas baffle 13. In general, due to the blocking of the water pipe arranged in the water pipe through hole 11, the flue gas flow above the water pipe is less, resulting in a lower temperature in the area above the water pipe through hole 11 on the heat exchange fin 1; whereas in the present application, as shown in FIG. 2, when the flue gas flow passes through the heat exchange fin 1 of the present application from bottom to top, due to the blocking of the first flue gas baffle 13 at the notch 12, the flue gas flow will be dispersed to both sides of the notch 12, which solves the problem of less flue gas in the area above the water pipe through hole 11, and can effectively increase the temperature above the water pipe through hole 11 of the heat exchange fin 1. Due to the blocking of the first flue gas baffle 13, there is less flue gas above the first flue gas baffle 13. In the present application, a first opening 131 is opened at the center of the first flue gas baffle 13 to allow a portion of the flue gas flow to flow upwardly from the first opening 131, so as to solve the problem of less flue gas above the first flue gas baffle 13. A flanging hole 14 is further arranged above the first flue gas baffle 13 to disperse the flue gas flow to both sides of the flanging hole 14, so as to solve the problem of less flue gas in the area of the water pipe through hole 11. Thus, in the present application, the flue gas flow of the heat exchange fin 1 is distributed uniformly, such that the temperature distribution of the heat exchange fin 1 is more uniform, so as to increase the lowest temperature of the heat exchange fin 1, reduce possibility of generation of the condensed water on the premise of ensuring heat exchange efficiency and prolong the service life of the heat exchange fin.

In an alternative embodiment, the plurality of water pipe through holes 11 include a plurality of rows of water pipe through holes 11 sequentially arranged along the flue gas flow direction, wherein each row of water pipe through holes 11 are arranged side by side along a direction perpendicular to the flue gas flow direction, and the water pipe through holes 11 in the plurality of rows are arranged in one-to-one correspondence along the flue gas flow direction.

Specifically, in the alternative embodiment, the water pipe through holes 11 are provided in a plurality of rows. When the water pipe is arranged in the heat exchange fin 1, the water pipe can sequentially pass through the plurality of water pipe through holes 11 that are arranged side by side in a row near the lower edge of the heat exchange fin 1, and then sequentially pass through the plurality of water pipe through holes 11 in the above row to achieve that the water pipe is arranged on the heat exchange fin 1. In the heating process, the water to be heated in the water pipe exchanges heat successively with the heat exchange fins 1 from bottom to top, and the water in the water pipe continues to heat up. Therefore, the water temperature in the water pipe near the upper edge of the heat exchange fin 1 is higher than the water temperature in the water pipe near the lower edge. However, because the water pipe is arranged in a plurality of rows, the temperature of the heat exchange fin 1 at the water pipe near the upper edge of the heat exchange fin 1 is lower than the temperature at the lower edge. Compared with the case where the water pipe arranged in a single row is always heated in the high temperature area of the heat exchange fin 1, the highest temperature of the water pipe arranged in a plurality of rows in the present application is even lower, thus the water pipe is not easy to scale, so as to prolong the service life of the heat exchange device.

Referring to FIG. 1, in a specific example, the heat exchange fin 1 is provided with two rows of water pipe through holes 11, and the water pipe through holes 11 in the two rows are arranged in one-to-one correspondence along the flue gas flow direction. That is, the water pipe through holes 11 at the corresponding positions of the two rows of water pipe through holes 11 are aligned up and down along the flue gas flow direction. The water pipe in the upper row of water pipe through holes 11 is shielded by the water pipe in the lower row of water pipe through holes 11, thereby reducing the flue gas flow in direct contact with the upper row of high-temperature water pipes, and the temperature of the heat exchange fin 1 corresponding to the upper row of water pipes is also lower than the temperature of the lower part, so as to avoid the continuous high-temperature heating of the upper row of high-temperature water pipes, so that the highest temperature in the entire water pipe is not too high, and the risk of fouling is reduced.

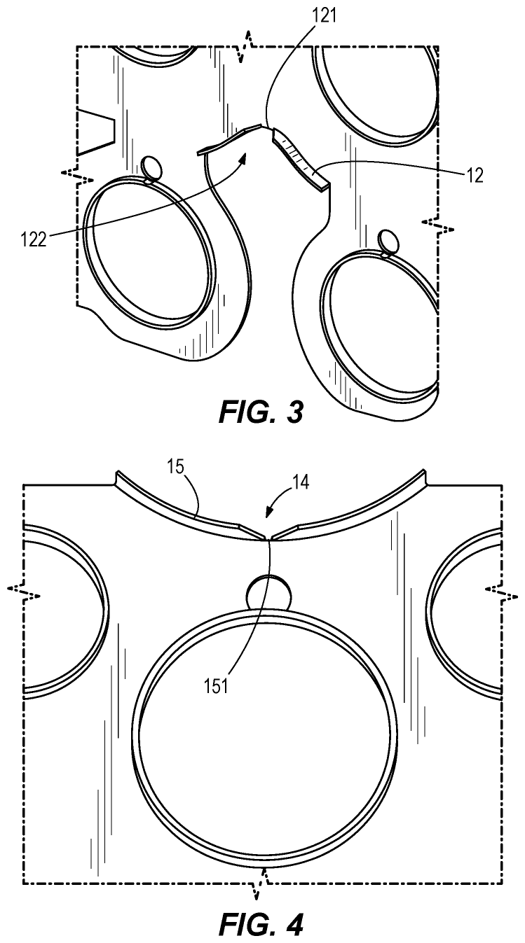

In an alternative embodiment, as shown in FIG. 3, a protruding portion 121 protruding toward an upper edge of the heat exchange fin 1 is formed at a side of the notch 12 that is close to the flanging hole 14.

Specifically, the protruding portion 121 is formed at a side of the notch 12 that is close to the flanging hole 14. That is, the upper portion of the notch 12 is provided as the protruding portion 121 protruding toward the upper edge of the heat exchange fin 1, such that the flue gas flow that flows into the notch 12 is collected toward the center of the notch 12 under the action of the first flue gas baffle 13 and the protruding portion 121 of the notch 12, and flows out from the first opening 131 of the first flue gas baffle 13, thereby increasing the amount of the flue gas flow flowing out of the center of the first flue gas baffle 13.

In an alternative embodiment, as shown in FIG. 3, the first flue gas baffle 13 is disposed at the protruding portion 121.

Specifically, the first flue gas baffle 13 is disposed along the edge of the protruding portion 121 of the notch 12, such that the first flue gas baffle 13 matches with the shape of the protruding portion 121, thereby the first flue gas baffle 13 can better block the flue gas flow on both sides of the notch 12 and the flue gas flow collected at the center, so that the flue gas flow on the heat exchange fin 1 is more uniform.

Preferably, the protruding portion 121 is an inverted V shape, an arc shape or a bell-shape curve shape. Thus, the shape of the protruding portion 121 may be selected to be an inverted V shape, an arc shape or a bell-shape curve shape, the shape of the first flue gas baffle 13 disposed correspondingly to the protruding portion 121 may also be an inverted V shape, an arc shape, or a bell-shape curve shape, and the first opening 131 may be opened at the tip of the center of the first flue gas baffle 13 or at the point of maximum curvature thereof, so that the gas flow in the center of the first flue gas baffle 13 can flow out.

The protruding portion 121 is preferably in the shape of a large downward opening such as an inverted V shape, an arc shape, or a bell-shape curve shape, such that the thickness of the heat exchange fin outside the water pipe through hole 11 is more uniform and consistent, so as to improve the uniformity of the heating of the water pipe in the circumferential direction. Of course, in practical applications, the protruding portion 121 and the first flue gas baffle 13 may also adopt other similar shapes, which is not limited in the present application.

In an alternative embodiment, a lower edge of the protruding portion 121 is located above the water pipe through hole 11 that is close to a lower edge of the heat exchange fin 1.

Specifically, it can be understood that the flue gas flow is less above the water pipe through hole 11 that is close to the lower edge of the heat exchange fin 1 due to the blockage by the water pipe in said water pipe through hole 11, and thus the lower edge of the protruding portion 121 is located above the water pipe through hole 11 that is close to the lower edge of the heat exchange fin 1. In a specific example, as shown in FIG. 1, the heat exchange fin 1 is provided with two rows, that is upper and lower rows of water pipe through holes 11, that is, the lower edge of the protruding portion 121 is located above the lower row of water pipe through holes 11. Under the action of the first flue gas baffle 13, the flue gas flow at the notch 12 can be diffused towards above the lower row of water pipe through holes 11, which solves the problem that the temperature in an area above the lower row of water pipe through holes 11 of the heat exchange fin 1 is low because the flue gas flow in this area is less due to the obstruction of the water pipe, improves the uniformity of the flue gas flow at the heat exchange fin 1, so as to improve the temperature uniformity on the heat exchange fin 1 and increase the lowest temperature, prevent generation of the condensed water under the premise of ensuring the heat exchange efficiency and prolong the service life of the heat exchange fin.

In an alternative embodiment, the flanging hole 14 is located above the water pipe through hole 11 that is close to an upper edge of the heat exchange fin 1.

Specifically, it can be understood that a flanging hole 14 is further arranged above the first flue gas baffle 13, so that the flue gas flow above the first flue gas baffle 13 can be diffused to the water pipe through holes 11 on both sides, so as to further compensate for the defect that the flue gas flow at the water pipe through holes 11 is less due to the obstruction of the water pipes. In a specific example, as shown in FIG. 1, the heat exchange fin 1 is provided with two rows, that is upper and lower rows of water pipe through holes 11, and the water pipe in the upper row of water pipe through holes 11 blocks the flue gas flow so that the flue gas flow in an area above the upper row of water pipe through holes 11 is sparse. The flanging hole 14 is provided at a position corresponding to the upper side of the upper row of water pipe through holes 11 above the first flue gas baffle 13, so that the flue gas flow can be diffused to an area above the upper row of water pipe through holes 11, which solves the problem that the temperature in the area above the upper row of water pipe through holes 11 of the heat exchange fin 1 is low because the flue gas flow in this area is less due to the obstruction of the upper row of water pipes, improves the uniformity of the flue gas flow at the heat exchange fin 1, so as to improve the temperature uniformity on the heat exchange fin 1 and increase the lowest temperature, prevent generation of the condensed water under the premise of ensuring the heat exchange efficiency and prolong the service life of the heat exchange fin.

In an alternative embodiment, at least one of the flanging holes 14 is provided with a through hole formed along the flue gas flow direction.

Specifically, it can be understood that the flanging holes 14 extend outward from the surface of the heat exchange fin 1 to form a flanging at which a through hole(s) is/are provided along the flue gas flow direction, such that a part of the flue gas flow passes upward through the through hole(s) in the flanging hole 14, which compensates for the defect that the flue gas flow above the flanging hole 14 is relatively sparse because the flanging hole 14 itself blocks the flue gas flow, and further improves the uniformity of the flue gas flow distribution on the heat exchange fin 1.

In an alternative embodiment, as shown in FIG. 4, a recessed portion 15 recessed toward the water pipe through hole 11 is formed at an upper edge of the heat exchange fin 1 correspondingly to the water pipe through hole 11.

Specifically, it can be understood that the flue gas flow above the flanging hole 14 is relatively sparse because the flanging hole 14 itself blocks the flue gas flow, and thus the second flue gas baffle 16 corresponding to the adjacent flanging hole 14 can be arranged on the upper edge of the heat exchange fin 1 corresponding to the respective water pipe through holes 11. Under the action of the second flue gas baffle 16, the flue gas flow above the upper row of water pipe through holes 11 is diffused above the flanging hole 14, which compensates for the defect that the flue gas flow above the flanging hole 14 is relatively sparse because the flanging hole 14 itself blocks the flue gas flow, and further improves the uniformity of the flue gas flow distribution on the heat exchange fin 1.

In practical application, if both sides of the water pipe through hole 11 are provided with the flanging holes 14, the second flue gas baffle 16 includes two parts corresponding to the two flanging holes 14 on both sides; if only one side of the water pipe through hole 11 is provided with the flanging hole 14, the second flue gas baffle 16 may be provided with at least one part corresponding to the flanging hole 14.

In an alternative embodiment, as shown in FIG. 4, a second opening 161 is formed at the center of the second flue gas baffle 16 corresponding to the same water pipe through hole 11.

Specifically, the second opening 161 may be formed at the center of the second flue gas baffle 16, so that part of the flue gas flow can flow out from the second opening 161 at the center of the second flue gas baffle 16, thereby the flue gas flow at the heat exchange fin 1 is more evenly distributed.

In an alternative embodiment, the lower edge of the heat exchange fin 1 is a straight line near the edge of the water pipe through hole 11.

Specifically, it can be understood that, in this embodiment, the lower edge of the heat exchange fin 1 is set as a straight line at a position corresponding to the water pipe through hole 11, such that the lower edge of the heat exchange fin 1 has a larger contact area with the flue gas flow, and the direction of flue gas flow can be optimized to improve the uniformity of temperature distribution of heat exchange fin 1.

To sum up, in the present application, the first flue gas baffle 13 and the flanging hole 14 are provided, and the first opening 131 is disposed at the center of the first flue gas baffle 13, so as to make the flue gas flow at the heat exchange fin 1 more uniform. The more uniform flue gas flow heats the heat exchange fins 1, so that the temperature distribution of the heat exchange fins 1 is more uniform, and the lowest temperature on the heat exchange fin 1 is effectively increased, such that the lowest temperature of the heat exchange fin 1 is higher than the dew point temperature of the heat exchange device, so as to effectively prevent generation of the condensed water under the premise of ensuring the heat exchange efficiency and prolong the service life of the heat exchange fin. In addition, in the present application, the water pipe through holes are preferably provided in a plurality of rows, and the plurality of rows of water pipe through holes 11 at corresponding positions are arranged in up and down one-to-one correspondence, so as to effectively reduce the temperature of the upper row of high-temperature water pipes, reduce the highest temperature of the water pipes, thereby effectively reducing the risk of fouling. Through experimental verification, when the dew point temperature of the heat exchange device is 49° C., the lowest temperature of the heat exchange fin of the present application is 53° C., which is higher than the dew point temperature, so that it is difficult to generate the condensed water for the heat exchange fin of the present application. In addition, through experimental verification, the highest temperature of the water pipe of the present application is 91.1ºC, and the highest temperature of the water pipe of the present application is lower than the temperature of 105° C. in the prior art, which can effectively reduce the risk of fouling and improve the service life of the heat exchange fin.

Based on the same principle, the embodiment further discloses a heat exchange device. The heat exchange device comprises two or more heat exchange fins 1 as described in the embodiment, wherein the two or more heat exchange fins 1 are sequentially stacked and assembled together.

The heat exchange device of this embodiment can be used for preparation of a water heater product, and of course, in practical application, the heat exchange device can also be used for other products, which are for illustrative purposes only.

Since the principle of the heat exchange device solving the problem is similar to that of the above heat exchange fin 1, the implementation of the heat exchange device can be found by referring to the implementation of the heat exchange fin 1, and will not be described again here.

The various embodiments in the specification are described in a progressive manner, and the same or similar parts between the various embodiments may be referred to each other, and each embodiment focuses on the differences from the other embodiments. In particular, the system embodiment is simply described since it is substantially similar to the method embodiment, and please refer to the description of the method embodiment for the relevant content.

The above descriptions are only embodiments of the present application and are not intended to limit the application. Various changes and modifications can be made to the present application by those skilled in the art. Any modifications, equivalents, improvements, etc. made within the spirit and scope of the present application are intended to be included within the scope of the claims of the present application.

1. A heat exchange fin comprising a plurality of water pipe through holes arranged side by side perpendicular to a flue gas flow direction, wherein a notch and a flanging hole are sequentially formed between adjacent water pipe through holes along the flue gas flow direction, an edge of the notch is provided with a first flue gas baffle, and a first opening is formed at a center of the first flue gas baffle.

2. The heat exchange fin according to claim 1, wherein the plurality of water pipe through holes include a plurality of rows of water pipe through holes sequentially arranged along the flue gas flow direction, wherein the water pipe through holes in each row are arranged side by side along a direction perpendicular to the flue gas flow direction, and the water pipe through holes in the plurality of rows are arranged in one-to-one correspondence along the flue gas flow direction.

3. The heat exchange fin according to claim 1, wherein a protruding portion protruding toward an upper edge of the heat exchange fin is formed at a side of the notch that is close to the flanging hole.

4. The heat exchange fin according to claim 3, wherein the first flue gas baffle is disposed at the protruding portion.

5. The heat exchange fin according to claim 3, wherein a lower edge of the protruding portion is located above the water pipe through hole that is close to a lower edge of the heat exchange fin.

6. The heat exchange fin according to claim 4, wherein the protruding portion is an inverted V shape, an arc shape or a bell-shape curve shape.

7. The heat exchange fin according to claim 1, wherein the flanging hole is located above the water pipe through hole that is close to an upper edge of the heat exchange fin.

8. The heat exchange fin according to claim 1, wherein at least one of the flanging holes is provided with a through hole along the flue gas flow direction.

9. The heat exchange fin according to claim 1, wherein a recessed portion recessed toward the water pipe through hole is formed at an upper edge of the heat exchange fin correspondingly to the water pipe through hole.

10. The heat exchange fin according to claim 9, wherein a second flue gas baffle corresponding to the flanging hole is disposed at the recessed portion.

11. The heat exchange fin according to claim 10, wherein a second opening is formed at a center of the second flue gas baffle corresponding to the water pipe through hole.

12. The heat exchange fin according to claim 1, wherein a lower edge of the heat exchange fin is a straight line near an edge of the water pipe through hole.

13. A heat exchange device comprising two or more heat exchange fins according to claim 1, wherein the two or more heat exchange fins are sequentially stacked and assembled together.

14. A heat exchange device including a fin, wherein the fin comprises a plurality of water pipe through holes arranged side by side perpendicular to a flue gas flow direction, wherein a notch and a flanging hole are sequentially formed between adjacent water pipe through holes along the flue gas flow direction, an edge of the notch is provided with a first flue gas baffle, and a first opening is formed at a center of the first flue gas baffle.

15. The heat exchange device according to claim 14, wherein the plurality of water pipe through holes include a plurality of rows of water pipe through holes sequentially arranged along the flue gas flow direction, wherein the water pipe through holes in each row are arranged side by side along a direction perpendicular to the flue gas flow direction, and the water pipe through holes in the plurality of rows are arranged in one-to-one correspondence along the flue gas flow direction.

16. The heat exchange device according to claim 14, wherein a protruding portion protruding toward an upper edge of the fin is formed at a side of the notch that is close to the flanging hole.

17. The heat exchange device according to claim 14, wherein a recessed portion recessed toward the water pipe through hole is formed at an upper edge of the fin correspondingly to the water pipe through hole.

18. The heat exchange device according to claim 17, wherein a second flue gas baffle corresponding to the flanging hole is disposed at the recessed portion.

19. The heat exchange device according to claim 18, wherein a second opening is formed at a center of the second flue gas baffle corresponding to the water pipe through hole.

20. A water heater product comprising the heat exchange device of claim 14.
